(19) United States
(12) Patent Application Publication
(10) Pub. No.: US 2013/0307750 A1
(43) Pub. Date: Nov. 21, 2013

(54) SWITCHING CIRCUIT AND WIRELESS COMMUNICATION SYSTEM INCLUDING THE SAME

(71) Applicant: SAMSUNG ELECTRO-MECHANICS CO. LTD., Gyeonggi-do (KR)

(72) Inventors: Yu Sin Kim, Gyeonggi-do (KR); Sung Hwan Park, Gyeonggi-do (KR)

(73) Assignee: Samsung Electro-Mechanics Co. Ltd., Gyeonggi-do (KR)

(21) Appl. No.: 13/801,839

(22) Filed: Mar. 13, 2013

(30) Foreign Application Priority Data
May 15, 2012 (KR) 10-2012-0051553

(51) Int. Cl. H01Q 1/50

(52) U.S. Cl. CPC H01Q 1/50
USPC 343/876

(57) ABSTRACT

Disclosed herein are a switching circuit and a wireless communication system including the same. In the case in which a control signal applied to a control terminal of a main switch is a first control signal, a first gate resistor is connected to the control terminal, such that the first control signal is applied to the control terminal of the main switch through the first gate resistor, in the case in which the control signal applied to the control terminal of the main switch is a second control signal, a second gate resistor is connected to the control terminal, such that the second control signal is applied to the control terminal of the main switch through the first gate resistor, and the first gate resistor and the second gate resistor have different resistance values, such the switching circuit may pass a multi-band high frequency signal therethrough.

### CROSS REFERENCE(S) TO RELATED APPLICATIONS

This application claims the benefit under 35 U.S.C. Section 119 of Korean Patent Application Serial No. 10-2012-0051553, entitled “Switching Circuit and Wireless Communication System Including the Same” filed on May 15, 2012, which is hereby incorporated by reference in its entirety into this application.

### BACKGROUND OF THE INVENTION

1. Technical Field

The present invention relates to a switching circuit and a wireless communication system including the same.

2. Description of the Related Art

A wireless communication system indicates a system carrying data on a carrier having a predetermined frequency to transmit and receive the data between terminals spaced apart from each other.

In accordance with the recent remarkable development of a wireless communication related technology, transmission and reception of data through various portable terminals have been enabled. Therefore, a frequency band of a carrier for transferring the data and a scheme of transferring the data have been diversified.

A typical example of a wireless communication scheme includes a cellular network such as GSM, or the like, WiFi, Bluetooth, and the like. Most of the smart mobile devices that have been recently released have been implemented so that all of these various wireless communication schemes may be utilized.

Meanwhile, required data may be extracted from wireless signals using different frequency bands through different signal processing modules.

Further, in accordance with the trend toward miniaturization and lightness of smart devices, technologies capable of using various wireless communication schemes by providing only a single antenna and connecting several signal processing modules to the signal antenna have been developed.

For example, in a high frequency switch circuit implemented by a single pole double throw (SPDT) as disclosed in Patent Document 1, each of the switches is provided between a first port and an antenna and between a second port and the antenna, such that a high frequency signal received through the antenna may be connected to the first port or the second port according to an operation of a switch.

In a wireless communication system implemented in a scheme as disclosed in Patent Document 1, at least two switches passing the high frequency signal therethrough are required.

However, since output power of the high frequency signal used in the wireless communication system is generally about 20 to 40 dBm, an area of about or 1×1 mm more is required in implementing a high frequency switch in order to smoothly pass or block this high output signal, such that there is a limitation in miniaturizing a system.

### RELATED ART DOCUMENT

[Patent Document]
(Patent Document 1) Korean Patent Laid-Open Publication No. 2008-0027849

### SUMMARY OF THE INVENTION

An object of the present invention is to provide a switching circuit in which the number of switches passing a high frequency signal therethrough may be reduced as compared to the related art, and a wireless communication system including the same.

According to an exemplary embodiment of the present invention, there is provided a switching circuit including: a main switch having a first terminal connected to an antenna, a second terminal connected to an input and output port, and a control terminal applied with a control signal, wherein in the case in which the control signal applied to the control terminal of the main switch is a first control signal, a first gate resistor is connected to the control terminal, such that the first control signal is applied to the control terminal of the main switch through the first gate resistor, wherein in the case in which the control signal applied to the control terminal of the main switch is a second control signal, a second gate resistor is connected to the control terminal, such that the second control signal is applied to the control terminal of the main switch through the first gate resistor, and wherein the first gate resistor and the second gate resistor have different resistance values.

The input and output port may include: a first port connected to a first high frequency signal processing module processing a GSM signal; and a second port connected to a second high frequency signal processing module processing a WiFi signal or a Bluetooth signal, the first control signal may be a control signal controlling the main switch to pass the GSM signal therethrough, the second control signal may be a control signal controlling the main switch to pass the WiFi signal or the Bluetooth signal therethrough, and the first gate resistor may have a resistance value larger than that of the second gate resistor.

According to another exemplary embodiment of the present invention, there is provided a switching circuit including: a main switch having a first terminal connected to an antenna, a second terminal connected to an input and output port, and a control terminal applied with a control signal; a first gate resistor having one end connected to the control terminal of the main switch; a second gate resistor having one end connected to the control terminal of the main switch; a first sub-switch having a first terminal connected to the first gate resistor, a second terminal connected to a control signal input terminal, and a control terminal applied with a first control signal; and a second sub-switch having a first terminal connected to the second gate resistor, a second terminal connected to the control signal input terminal, and a control terminal applied with a second control signal, wherein the first gate resistor and the second gate resistor have different resistance values.

The input and output port may include: a first port connected to a first high frequency signal processing module processing a GSM signal; and a second port connected to a second high frequency signal processing module processing a WiFi signal or a Bluetooth signal, the first control signal may be a control signal applied to the control signal input terminal to control the main switch to pass the GSM signal therethrough, the second control signal may be a control signal applied to the control signal input terminal to control the main switch to pass the WiFi signal or the Bluetooth signal therethrough, and the first gate resistor may have a resistance value larger than that of the second gate resistor.

According to still another exemplary embodiment of the present invention, there is provided a switching circuit including: a main switch having a first terminal connected to an antenna, a second terminal connected to an input and output port, and a control terminal applied with a control signal; a third sub-switch having a first terminal connected to the control terminal of the main switch and a control terminal applied with a first control signal; a fourth sub-switch having a first terminal connected to the control terminal of the main switch and a control terminal applied with a second control signal; a first gate resistor having one end connected to a second terminal of the third sub-switch and the other end connected to a control signal input terminal; and a second gate resistor having one end connected to a second terminal of the fourth sub-switch and the other end connected to the control signal input terminal, wherein the first gate resistor and the second gate resistor have different resistance values.

According to still another exemplary embodiment of the present invention, there is provided a switching circuit including: a main switch having a first terminal connected to an antenna, a second terminal connected to an input and output port, and a control terminal applied with a control signal; a third sub-switch having a first terminal connected to the control terminal of the main switch and a control terminal applied with a first control signal; a fourth sub-switch having a first terminal connected to the control terminal of the main switch and a control terminal applied with a second control signal; a first gate resistor having one end connected to a second terminal of the third sub-switch; a second gate resistor having one end connected to a second terminal of the fourth sub-switch; a first sub-switch having a first terminal connected to the other end of the first gate resistor, a second terminal connected to a control signal input terminal, and a control terminal applied with the first control signal; and a second sub-switch having a first terminal connected to the other end of the second gate resistor, a second terminal connected to the control signal input terminal, and a control terminal applied with the second control signal, wherein the first gate resistor and the second gate resistor have different resistance values.

According to still another exemplary embodiment of the present invention, there is provided a wireless communication system including: an antenna transmitting or receiving at least two kinds of signals selected among a GSM signal, a WiFi signal, and a Bluetooth signal; a first port connected to a first high frequency signal processing module processing the GSM signal; a second port connected to a second high frequency signal processing module processing the WiFi signal or the Bluetooth signal; a switching circuit connecting or blocking a path between the antenna and the first port or a path between the antenna and the second port; and a controlling unit controlling the switching circuit, wherein the switching circuit includes: a main switch having a first terminal connected to the antenna, a second terminal connected to the first and second ports, and a control terminal applied with a control signal, in the case in which the control signal applied to the control terminal of the main switch is a first control signal, a first gate resistor being connected to the control terminal, such that the first control signal is applied to the control terminal of the main switch through the first gate resistor, in the case in which the control signal applied to the control terminal of the main switch is a second control signal, a second gate resistor being connected to the control terminal, such that the second control signal is applied to the control terminal of the main switch through the first gate resistor, and the first gate resistor and the second gate resistor having different resistance values.

The first control signal may be a control signal controlling the main switch to pass the GSM signal therethrough, the second control signal may be a control signal controlling the main switch to pass the WiFi signal or the Bluetooth signal therethrough, and the first gate resistor may have a resistance value larger than that of the second gate resistor.

The wireless communication system may further include: a low pass filter disposed between the second terminal of the main switch and the first port; and a high pass filter disposed between the second terminal of the main switch and the second port.

The wireless communication system may further include: a first switch having one end connected to the first terminal of the main switch; a second switch having one end connected to the first terminal of the main switch; and a diplexer having a first terminal connected to the other end of the first switch, a second terminal connected to the other end of the second switch, and a third terminal connected to the antenna, wherein the first switch, the second switch, and the diplexer are disposed between the antenna and the first terminal of the main switch, and wherein the first switch is turned on or off by the first control signal and the second switch is turned on or off by the second control signal.

According to still another exemplary embodiment of the present invention, there is provided a wireless communication system including: an antenna transmitting or receiving at least two kinds of signals selected among a GSM signal, a WiFi signal, and a Bluetooth signal; a first port connected to a first high frequency signal processing module processing the GSM signal; a second port connected to a second high frequency signal processing module processing the WiFi signal or the Bluetooth signal; a switching circuit connecting or blocking a path between the antenna and the first port or a path between the antenna and the second port; and a controlling unit controlling the switching circuit, wherein the switching circuit includes: a main switch having a first terminal connected to the antenna, a second terminal connected to the first and second ports, and a control terminal applied with a control signal; a third sub-switch having a first terminal connected to the control terminal of the main switch and a control terminal applied with a first control signal; a fourth sub-switch having a first terminal connected to the control terminal of the main switch and a control terminal applied with a second control signal; a first gate resistor having one end connected to a second terminal of the third sub-switch; a second gate resistor having one end connected to a second terminal of the fourth sub-switch; a first sub-switch having a first terminal connected to the other end of the first gate resistor, a second terminal connected to a control signal input terminal, and a control terminal applied with the first control signal; and a second sub-switch having a first terminal connected to the other end of the second gate resistor, a second terminal connected to the control signal input terminal, and a control terminal applied with the second control signal, the first gate resistor and the second gate resistor having different resistance values.

### BRIEF DESCRIPTION OF THE DRAWINGS

FIG. 1 is a view schematically showing an equivalent circuit of a switch for passing a high frequency signal implemented by an NMOS.

FIG. 2 is a view schematically showing a switch for passing a high frequency signal including a gate resistor.

FIG. 3 is a view showing an equivalent circuit of the switch of FIG. 2 in view of a channel transit time.

FIG. 4 is a view schematically showing a change in capacitor charging voltage of FIG. 3.

FIG. 5 is a view schematically showing a wireless communication system according to a first exemplary embodiment of the present invention.

FIG. 6 is a view schematically showing a switching circuit according to an exemplary embodiment of the present invention.

FIGS. 7A to 7D are views describing an operation principle of the switching circuit according to the exemplary embodiment of the present invention, wherein FIG. 7A is a view schematically showing a waveform of a first control signal; FIG. 7B is a view schematically showing a waveform of a capacitor charging voltage of a main switch in a state in which the first control signal is applied; FIG. 7C is a view schematically showing a waveform of a second control signal; and FIG. 7D is a view schematically showing a waveform of a capacitor charging voltage of the main switch in a state in which the second control signal is applied.

FIG. 8 is a view schematically showing a switching circuit according to another exemplary embodiment of the present invention.

FIG. 9 is a view schematically showing a switching circuit according to still another exemplary embodiment of the present invention.

FIG. 10 is a view schematically showing a wireless communication system according to a second exemplary embodiment of the present invention.

FIG. 11 is a view schematically showing a wireless communication system according to a third exemplary embodiment of the present invention.

FIG. 12 is a view schematically showing a wireless communication system according to a fourth exemplary embodiment of the present invention.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. These embodiments may be provided so that this disclosure will be thorough and complete, and will fully convey the scope of the invention to those skilled in the art. Like reference numerals throughout the description denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, a configuration and an acting effect of exemplary embodiments of the present invention will be described in more detail with reference to the accompanying drawings.

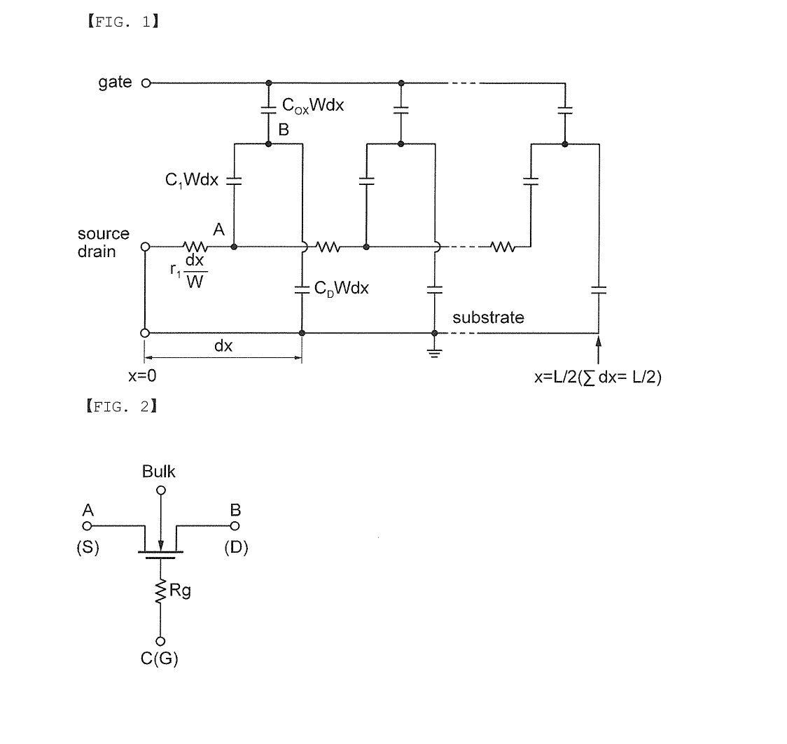

FIG. 1 is a view schematically showing an equivalent circuit of a switch for passing a high frequency signal implemented by an NMOS; and FIG. 2 is a view schematically showing a switch for passing a high frequency signal including a gate resistor.

Referring to FIG. 1, a high frequency band switch may be implemented by a polysilicon gate NMOS of which an equivalent circuit may be represented as an equivalent circuit in which a plurality of capacitances and resistors are combined in series and parallel with each other.

Here, C_{OX} indicates a gate oxide capacitance, C₁ indicates a gate inversion capacitance, C_{D} indicates a gate depletion capacitance, Wd indicates a channel width, and L indicates a channel length.

In a transistor of FIG. 1, a channel transit time may be defined by an RC time constant of the channel. A circuit for this may be represented in a form in which a resistor Rg is connected to a gate of the NMOS as shown in FIG. 2.

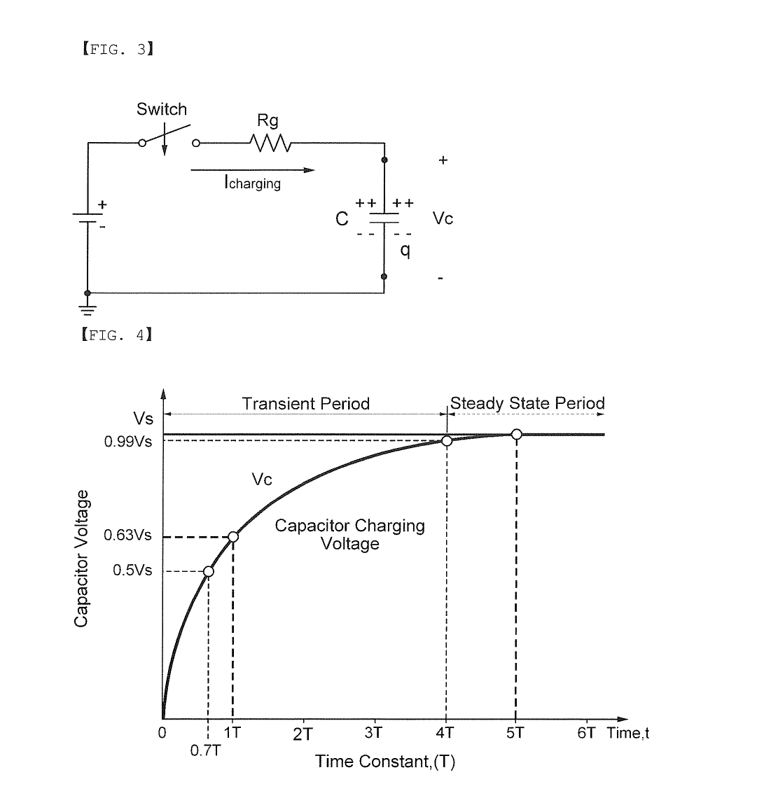

FIG. 3 is a view showing an equivalent circuit of the switch of FIG. 2 in view of a channel transit time; and FIG. 4 is a view schematically showing a change in capacitor charging voltage of FIG. 3.

In FIG. 3, a gate resistor Rg and a gate channel capacitance C may be represented by a function of the time constant. In addition, it may be appreciated from FIG. 4 that capacitor charging voltage Vc is completely charged after 5T elapses.

Meanwhile, a high frequency signal used in wireless communication includes a GMS signal, a WiFi signal, a Bluetooth signal, and the like. These high frequency signals have a large difference in view of various characteristics such as output power, switching timing characteristics, and the like.

Particularly, in the case of a high frequency switch serving to pass or block the high frequency signal, switch withstand voltage or a switching time needs to be optimized according to characteristics of a high frequency signal to be passed in order to prevent loss of the signal and stably operate the high frequency switch.

For example, the GSM signal generally requires output power of about 35 dBm and a switching time of about 2 μs. On the other hand, the WiFi signal or the Bluetooth signal requires output power of about 20 dBm and a switching time of about 400 ns.

Therefore, the high frequency switch for passing the GSM signal requires withstand voltage capable of withstanding about 35 dBm and a switching time capable of satisfying a condition of about 2 μs. In addition, the high frequency switch for passing the WiFi signal or the Bluetooth signal requires withstand voltage capable of withstanding about 20 dBm and a switching time capable of satisfying a condition of about 400 ns.

Here, in the case in which the high frequency switch is implemented by a metal oxide semiconductor field effect transistor such as an NMOS, or the like, a plurality of transistors having a predetermined withstand voltage are connected in series with each other to form a stack, thereby making it possible to satisfy required withstand voltage.

Therefore, the larger the withstand voltage, the more the number of stacks. As a result, an occupied area in a circuit increases. The general high frequency switch for the GSM signal is implemented to have an area of about 2×2 mm², and the high frequency switch for the WiFi signal or the Bluetooth signal is implemented to have an area of about 1×1 mm².

That is, the high frequency switch for the GSM signal occupies an area about four times larger than that of the high frequency switch for the WiFi signal or the Bluetooth signal.

In addition, the switching time means a time from a point in time in which a signal turning on the high frequency switch is applied to a point in time in which the capacitor charging voltage Vc becomes maximum. Referring to FIG. 4, the switching time may be 5T.

That is, in the case of the high frequency switch for the GSM signal, it is sufficient that the capacitor charging voltage Vc becomes maximum in about 2 μs; however, in the case of the high frequency switch for the WiFi signal or the Bluetooth signal, the capacitor charging voltage Vc needs to become maximum in about 400 ns. As a result, the high frequency switch for the WiFi signal or the Bluetooth signal needs to satisfy the switching time five times faster than that of the high frequency switch for the GSM signal.

Meanwhile, as described above, considering that the switching time may be determined according to the RC time constant shown in FIG. 3, the switching time may be adjusted by changing an R value, that is, a gate resistance value. The present inventor has developed a switching circuit capable of passing various high frequency signals such as the GSM signal, the WiFi signal, the Bluetooth signal, and the like, using this principle.

In addition, the present inventor has developed the switching circuit capable of selectively passing two kinds or more of high frequency signals using these characteristics. Therefore, the number of high frequency switches that have been two or more in the related art may be reduced to 1.

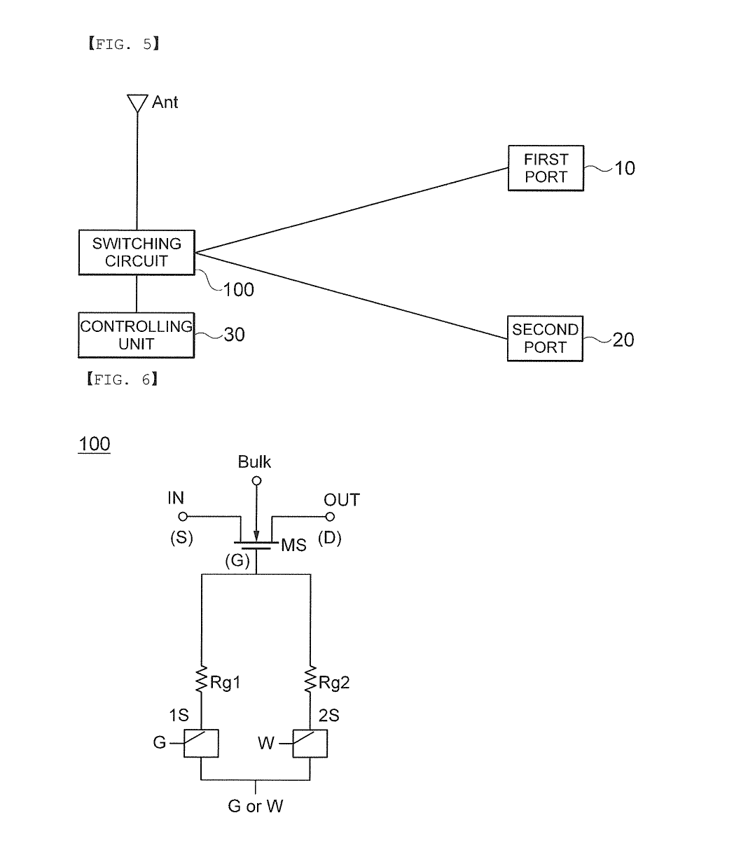

FIG. 5 is a view schematically showing a wireless communication system according to a first exemplary embodiment of the present invention.

Referring to FIG. 5, the wireless communication system according to the first preferred embodiment of the present invention may include an antenna Ant, a switching circuit 100, a first port 10, a second port 20, and a controlling unit 30.

The first port 10 may be connected to a first high frequency signal processing module (not shown) processing a GSM signal, and the second port 20 may be connected to a second high frequency signal processing module (not shown) processing a WiFi signal or a Bluetooth signal.

In addition, the antenna (Ant) may serve to transmit and receive at least two kinds of signals selected among the GSM signal, the WiFi signal, and the Bluetooth signal.

Next, the switching circuit 100 may serve to connect or block a path between the antenna Ant and the first port 10 or a path between the antenna Ant and the second port 20 and may be operated according to a control signal generated in the controlling unit 30.

Here, the controlling unit 30 may be implemented by a baseband general purpose input output (GPIO), or the like, and generate a digital control signal for controlling the switching circuit 100.

Meanwhile, the controlling unit 30 may control a main switch MS for passing the high frequency signal in the switching circuit 100 to become a turn-on or turn-off state through the control signal and change a gate resistor connected to a gate, which is a control terminal, of the main switch MS as needed.

FIG. 6 is a view schematically showing a switching circuit 100 according to an exemplary embodiment of the present invention.

Referring to FIG. 6, the switching circuit 100 according to the exemplary embodiment of the present invention may include a main switch MS, a first gate resistor Rg1, a second gate resistor Rg2, a first sub-switch 1S, and a second sub-switch 2S.

The main switch MS may be implemented by a general MOS transistor and have a source connected to the antenna Ant, a drain connected to the first port 10 and the second port 20, and a gate applied with the control signal generated in the controlling unit 30.

Therefore, the main switch MS may serve to connect or block the path between the antenna Ant and the first port 10 and serve to connect or block the path between the antenna Ant and the second port 20.

Meanwhile, a first gate resistor Rg1 and a second gate resistor Rg2 are connected to the gate of the main switch MS. Here, the first gate resistor Rg1 and the second gate resistor Rg2 have different resistance values.

Next, the first sub-switch 1S is connected to the other end of the first gate resistor Rg1, the second sub-switch 2S is connected to the other end of the second gate resistor Rg2, and a control signal input terminal is connected to the other ends of the first and second sub-switches 1S and 2S.

Here, a first control signal G is applied to a control terminal of the first sub-switch 1S, and a second control signal W is applied to a control terminal of the second sub-switch 2S.

In addition, the control signals generated in the above-mentioned controlling unit 30 may be divided into the first control signal G and the second control signal W. For example, the control for passing the GSM signal may be defined as the first control signal G, and the control signal for passing the WiFi signal or the Bluetooth signal may be defined as the second control signal W.

In addition, the first control signal G and the second control signal W may be applied to the control signal input terminal, and turn-on or turn-off of the first and second sub-switches 1S and 2S may be controlled according to an H or L state of the first and second control signals G and W.

In the case of intending to pass the GSM signal, the first control signal G becomes H and the second control signal W becomes L, such that the first sub-switch 1S becomes a turn-on state and an H signal passing through the first gate resistor Rg1 is applied to the gate of the main switch MS.

In the case of intending to pass the WiFi signal or the Bluetooth signal, the second control signal W becomes H and the first control signal G becomes L, such that the second sub-switch 2S becomes a turn-on state and an H signal passing through the second gate resistor Rg2 is applied to the gate of the main switch MS.

Therefore, the main switch MS may pass the GSM signal therethrough or pass the WiFi signal or the Bluetooth signal therethrough.

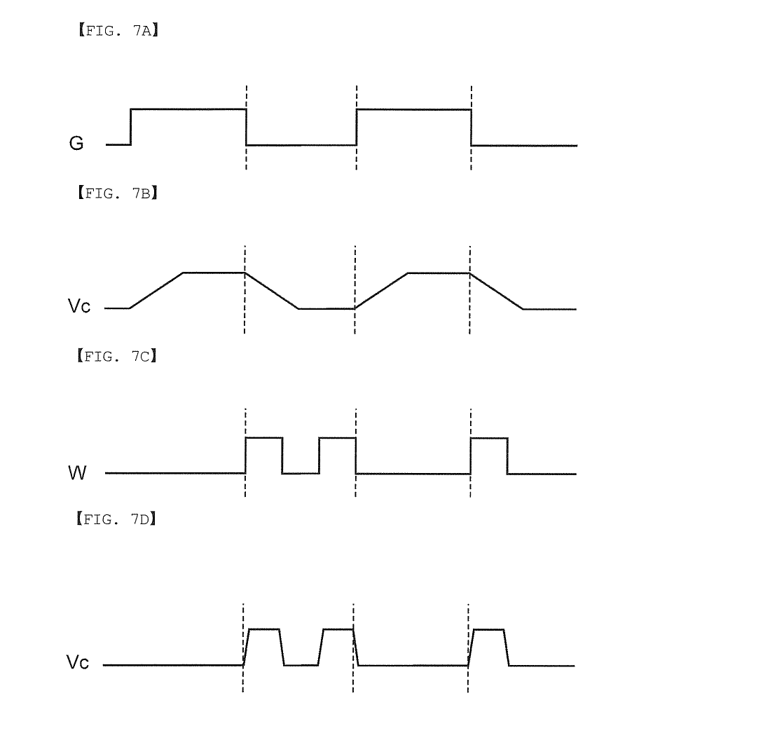

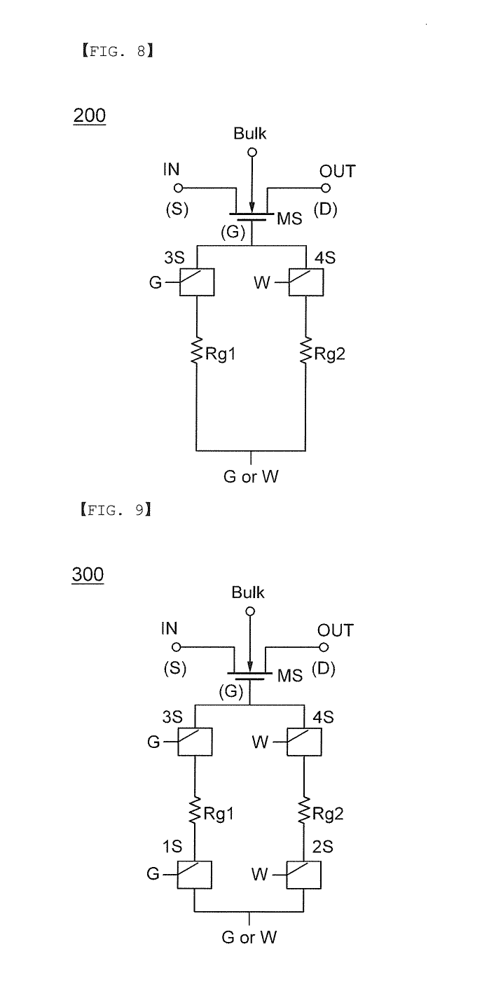

FIGS. 7A to 7D are views describing an operation principle of the switching circuit 100 according to the exemplary embodiment of the present invention, wherein FIG. 7A is a view schematically showing a waveform of a first control signal G; FIG. 7B is a view schematically showing a waveform of a capacitor charging voltage Vc of a main switch MS in a state in which the first control signal G is applied; FIG. 7C is a view schematically showing a waveform of a second control signal W; and FIG. 7D is a view schematically showing a waveform of a capacitor charging voltage Vc of the main switch MS in a state in which the second control signal W is applied.

The wireless communication system capable of processing both of the GSM signal and the WiFi signal is generally implemented as a time division duplex (TDD) system processing data by dividing a time rather than simultaneously processing two kinds of signals.

The case in which both of the first control signal G and the second control signal W do not simultaneously become an H state based on this TDD system is shown in FIGS. 7A to 7D.

Referring to FIGS. 7A to 7D, the first and second control signals G and W are not overlapped with each other, but are generated as independent timing signals. When the first sub-switch 1S is turned on by the first control signals G, the first gate resistor Rg1 is connected to the main switch MS, and in the case in which the second sub-switch 2S is turned on by the second control signal W, the second gate resistor Rg2 is connected to the main switch MS.

Here, the first gate resistor Rg1 may be determined to have a value larger than that of the second gate resistor Rg2.

Therefore, as shown in FIGS. 7B and 7D, a change rate (See FIG. 7B) of the capacitor charging voltage Vc in the case in which the first control signal G is applied is smaller than that (See FIG. 7D) of the capacitor charging voltage Vc in the case in which the second control signal W is applied.

This phenomenon is a result of applying a principle that the time constant of the RC equivalent circuit is changed according to a magnitude of the gate resistance as described above with reference to FIG. 4, such that a time required for the capacitor charging voltage Vc to become a maximum value is changed.

In addition, the fact that the switching time is five times or more slower in the GSM signal than in the WiFi signal has been described above.

In the switching circuit 100 according to the exemplary embodiment of the present invention, since a gate resistance value may be selectively applied, it is possible to decrease the switching time in the case of intending to pass the GSM signal and it is possible to increase the switching time in the case of intending to pass the WiFi signal.

Meanwhile, in a state in which the GSM signal and the WiFi signal are received together through the antenna Ant, during a time in which the first control signal G is H, both of the GSM signal and the WiFi signal pass through the main switch MS.

However, during the time in which the first control signal G is H, since the first gate resistor Rg1 is connected to the gate of the main switch MS, a switching time condition of the WiFi signal may not be satisfied.

Therefore, the GSM signal passing through the main switch MS at this time may pass through the first port 10 and be then processed and used in the first signal processing module. However, since the WiFi signal passes through the main switch MS in a state in which the switching time condition is not satisfied, the WiFi signal is recognized as noise, such that it is not reflected as valid data.

Meanwhile, in a state in which the GSM signal and the WiFi signal are received together through the antenna Ant, during a time in which the second control signal W is H, both of the GSM signal and the WiFi signal pass through the main switch MS.

However, the second control signal W for passing the WiFi signal has a clock frequency higher than that of the first control signal G.

Therefore, the WiFi signal passing through the main switch MS during the time in which the second control signal W is H may be reflected as valid data in the second signal processing module. However, the GSM signal passing through the main switch MS during this time is not reflected as valid data in the first signal processing module.

Further, according to this principle, even in the case of a system that is not the TDD system, the GSM signal and the WiFi signal may be separately used due to differences in a switching time and a clock frequency between the case in which the first gate resistor Rg1 is connected to the gate of the main switch (MS) and the second gate resistor Rg2 is connected thereto.

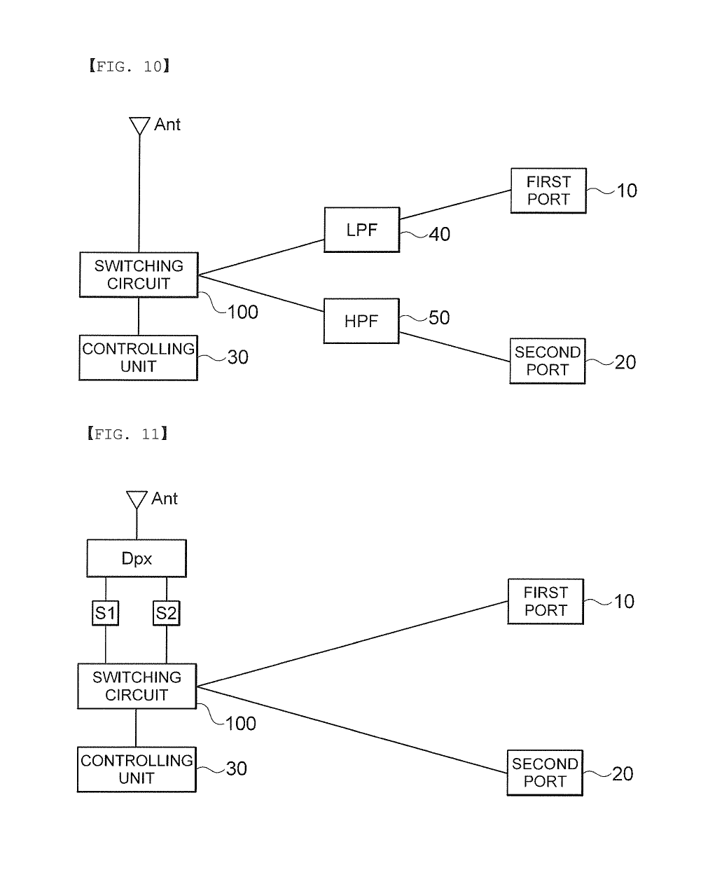

FIG. 8 is a view schematically showing a switching circuit 200 according to another exemplary embodiment of the present invention.

Referring to FIG. 8, the switching circuit 200 according to another exemplary embodiment of the present invention may include a main switch MS, a third sub-switch 3S, a fourth sub-switch 4S, a first gate resistor Rg1, and a second gate resistor Rg2.

In the switching circuit 200 according to the present embodiment, one end of the third sub-switch 3S and one end of the fourth sub-switch 4S are connected to a gate of the main switch MS, one end of the first gate resistor Rg1 is connected to the other end of the third sub-switch 3S, and one end of the second gate resistor Rg2 is connected to the other end of the fourth sub-switch 4S, unlike the exemplary embodiment described above with reference to FIG. 6.

Here, a control signal input terminal is connected to the other end of the first gate resistor Rg1 and the other end of the second gate resistor Rg2.

In addition, a first control signal G is applied to a control terminal of the third sub-switch 3S, and a second control signal W is applied to a control terminal of the fourth sub-switch 4S.

Therefore, in the case of intending to pass the GSM signal, the first control signal G becomes H and the second control signal W becomes L, such that the third sub-switch 3S becomes a turn-on state and an H signal passing through the first gate resistor Rg1 is applied to the gate of the main switch MS.

In the case of intending to pass the WiFi signal or the Bluetooth signal, the second control signal W becomes H and the first control signal G becomes L, such that the fourth sub-switch 4S becomes a turn-on state and an H signal passing through the second gate resistor Rg2 is applied to the gate of the main switch MS.

FIG. 9 is a view schematically showing a switching circuit 300 according to still another exemplary embodiment of the present invention.

Referring to FIG. 9, the switching circuit 300 according to still another exemplary embodiment of the present invention may include a main switch MS, a first sub-switch 1S, a second sub-switch 2S, a third sub-switch 3S, a fourth sub-switch 4S, a first gate resistor Rg1, and a second gate resistor Rg2.

The switching circuit 300 according to the present embodiment includes four sub-switches unlike the exemplary embodiment described above with reference to FIG. 6 and the exemplary embodiment described above with reference to FIG. 8. As described above, the number of sub-switches included between a gate of the main switch MS and a control signal input terminal is increased, thereby making it possible to reduce a malfunction or a circuit deterioration phenomenon due to a leakage signal leaked through parasitic capacitance formed between a source and the gate of the main switch MS.

Meanwhile, unlike the main switch MS that is to pass the high frequency signal therethrough, the sub-switches passing a first control signal G or a second control signal, which is a digital signal, therethrough have withstand voltage corresponding to ⅓ or less of that of the main switch MS and a switch size corresponding to about 1/10 of that of the main switch MS.

Therefore, even though a plurality of sub-switches are added instead of reducing one main switch MS, the entire size of the switch circuit 300 may be reduced as compared to the related art.

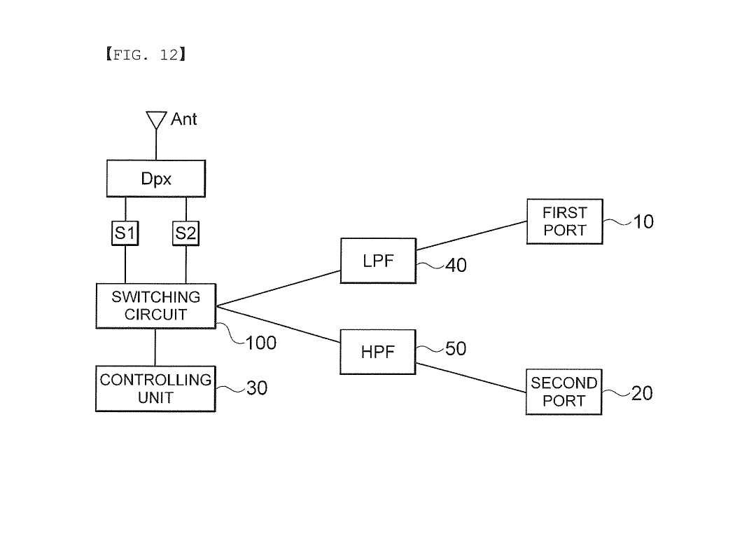

FIG. 10 is a view schematically showing a wireless communication system according to a second exemplary embodiment of the present invention.

Referring to FIG. 10, the wireless communication system according to the second exemplary embodiment of the present invention may further include a low pass filter 40 and a high pass filter 50 as compared to the wireless communication system according to the first exemplary embodiment described above with reference to FIG. 5.

Here, the low pass filter 40 may be provided between a drain terminal of a main switch MS and a first port 10, and the high pass filter 50 may be provided between the drain terminal of the main switch MS and a second port 20.

As described above, in a state in which a GSM signal and a WiFi signal are received together through the antenna Ant, both of the GSM signal and the WiFi signal pass through the main switch MS.

A signal processed in a signal processing module through the first port 10 or the second port 20 is filtered by a predetermined portion due to differences in a switching time condition and a clock frequency of a control signal; however, it may act as a kind of noise in view of the entire wireless communication system.

When the wireless communication system includes the low pass filter 40 and the high pass filter 50 as shown in FIG. 10, the WiFi signal or the Bluetooth signal among signals output to the first port 10 is filtered through the low pass filter 40, and the GSM signal among signals output to the second port 20 is filtered through the high pass filter 50, thereby making it possible to reduce the noise.

FIG. 11 is a view schematically showing a wireless communication system according to a third exemplary embodiment of the present invention.

Referring to FIG. 11, the wireless communication system according to the third exemplary embodiment of the present invention may further include a diplexer Dpx, a first switch S1, and a second switch S2 that are disposed between an antenna Ant and a switching circuit 100.

That is, signals received through the antenna Ant are input to a third terminal of the diplexer Dpx to be separated into a GSM signal and a WiFi signal. The GSM signal is input to the first switch S1 through a first terminal of the diplexer Dpx, and the WiFi signal is input to the second switch S2 through a second terminal of the diplexer Dpx.

Here, the first switch S1 is controlled to become a turn-on or turn-off state by a first control signal G and the second switch S2 is controlled to become a turn-on or turn-off state by a second control signal W, such that the signals received through the diplexer Dpx may be subjected to a filtering process before being input to the switching circuit 100.

Therefore, the noise of the entire wireless communication system may be further reduced.

FIG. 12 is a view schematically showing a wireless communication system according to a fourth exemplary embodiment of the present invention.

Referring to FIG. 12, the wireless communication system according to the fourth exemplary embodiment of the present invention may be implemented to include all of the low pass filter 40 and the high pass filter 50 described in the above-mentioned second exemplary embodiment and the diplexer Dpx, the first switch S1, and the second switch S2 described in the above-mentioned third exemplary embodiment.

Therefore, the noise of the entire wireless communication system may be further reduced.

The switching circuit according to the exemplary embodiments of the present invention configured as described above may be utilized as a high frequency switch passing the GSM signal therethrough and may also be utilized as a high frequency switch passing the WiFi signal or the Bluetooth signal therethrough. Therefore, the utilization width of the switching circuit may be widened.

In addition, according to the exemplary embodiments of the present invention, the number of high frequency switches that should be included in the wireless communication system transmitting and receiving various high frequency signals such as the GSM signal, the WiFi signal, the Bluetooth signal, and the like, may be reduced. Therefore, a size and a manufacturing cost of the wireless communication system may be reduced.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A switching circuit comprising:
a main switch having a first terminal connected to an antenna, a second terminal connected to an input and output port, and a control terminal applied with a control signal,
wherein in the case in which the control signal applied to the control terminal of the main switch is a first control signal, a first gate resistor is connected to the control terminal, such that the first control signal is applied to the control terminal of the main switch through the first gate resistor,
wherein in the case in which the control signal applied to the control terminal of the main switch is a second control signal, a second gate resistor is connected to the control terminal, such that the second control signal is applied to the control terminal of the main switch through the first gate resistor, and
wherein the first gate resistor and the second gate resistor have different resistance values.

2. The switching circuit according to claim 1, wherein the input and output port includes:
a first port connected to a first high frequency signal processing module processing a GSM signal; and
a second port connected to a second high frequency signal processing module processing a WiFi signal or a Bluetooth signal,
wherein the first control signal is a control signal controlling the main switch to pass the GSM signal therethrough,
wherein the second control signal is a control signal controlling the main switch to pass the WiFi signal or the Bluetooth signal therethrough, and
wherein the first gate resistor has a resistance value larger than that of the second gate resistor.

3. A switching circuit comprising:
a main switch having a first terminal connected to an antenna, a second terminal connected to an input and output port, and a control terminal applied with a control signal;
a first gate resistor having one end connected to the control terminal of the main switch;
a second gate resistor having one end connected to the control terminal of the main switch;
a first sub-switch having a first terminal connected to the first gate resistor, a second terminal connected to a control signal input terminal, and a control terminal applied with a first control signal; and
a second sub-switch having a first terminal connected to the second gate resistor, a second terminal connected to the control signal input terminal, and a control terminal applied with a second control signal,
wherein the first gate resistor and the second gate resistor have different resistance values.

4. The switching circuit according to claim 3, wherein the input and output port includes:
a first port connected to a first high frequency signal processing module processing a GSM signal; and
a second port connected to a second high frequency signal processing module processing a WiFi signal or a Bluetooth signal,
wherein the first control signal is a control signal applied to the control signal input terminal to control the main switch to pass the GSM signal therethrough,
wherein the second control signal is a control signal applied to the control signal input terminal to control the main switch to pass the WiFi signal or the Bluetooth signal therethrough, and
wherein the first gate resistor has a resistance value larger than that of the second gate resistor.

5. A switching circuit comprising:
a main switch having a first terminal connected to an antenna, a second terminal connected to an input and output port, and a control terminal applied with a control signal;
a third sub-switch having a first terminal connected to the control terminal of the main switch and a control terminal applied with a first control signal;
a fourth sub-switch having a first terminal connected to the control terminal of the main switch and a control terminal applied with a second control signal;
a first gate resistor having one end connected to a second terminal of the third sub-switch and the other end connected to a control signal input terminal; and
a second gate resistor having one end connected to a second terminal of the fourth sub-switch and the other end connected to the control signal input terminal,
wherein the first gate resistor and the second gate resistor have different resistance values.

6. The switching circuit according to claim 5, wherein the input and output port includes:
a first port connected to a first high frequency signal processing module processing a GSM signal; and
a second port connected to a second high frequency signal processing module processing a WiFi signal or a Bluetooth signal,
wherein the first control signal is a control signal applied to the control signal input terminal to control the main switch to pass the GSM signal therethrough,
wherein the second control signal is a control signal applied to the control signal input terminal to control the main switch to pass the WiFi signal or the Bluetooth signal therethrough, and
wherein the first gate resistor has a resistance value larger than that of the second gate resistor.

7. A switching circuit comprising:
a main switch having a first terminal connected to an antenna, a second terminal connected to an input and output port, and a control terminal applied with a control signal;
a third sub-switch having a first terminal connected to the control terminal of the main switch and a control terminal applied with a first control signal;
a fourth sub-switch having a first terminal connected to the control terminal of the main switch and a control terminal applied with a second control signal;
a first gate resistor having one end connected to a second terminal of the third sub-switch;
a second gate resistor having one end connected to a second terminal of the fourth sub-switch;
a first sub-switch having a first terminal connected to the other end of the first gate resistor, a second terminal connected to a control signal input terminal, and a control terminal applied with the first control signal; and
a second sub-switch having a first terminal connected to the other end of the second gate resistor, a second terminal connected to the control signal input terminal, and a control terminal applied with the second control signal,
wherein the first gate resistor and the second gate resistor have different resistance values.

8. The switching circuit according to claim 7, wherein the input and output port includes:
a first port connected to a first high frequency signal processing module processing a GSM signal; and
a second port connected to a second high frequency signal processing module processing a WiFi signal or a Bluetooth signal,
wherein the first control signal is a control signal applied to the control signal input terminal to control the main switch to pass the GSM signal therethrough,
wherein the second control signal is a control signal applied to the control signal input terminal to control the main switch to pass the WiFi signal or the Bluetooth signal therethrough, and
wherein the first gate resistor has a resistance value larger than that of the second gate resistor.

9. A wireless communication system comprising:
an antenna transmitting or receiving at least two kinds of signals selected among a GSM signal, a WiFi signal, and a Bluetooth signal;
a first port connected to a first high frequency signal processing module processing the GSM signal;
a second port connected to a second high frequency signal processing module processing the WiFi signal or the Bluetooth signal;
a switching circuit connecting or blocking a path between the antenna and the first port or a path between the antenna and the second port; and
a controlling unit controlling the switching circuit,
wherein the switching circuit includes:
a main switch having a first terminal connected to the antenna, a second terminal connected to the first and second ports, and a control terminal applied with a control signal,
in the case in which the control signal applied to the control terminal of the main switch is a first control signal, a first gate resistor being connected to the control terminal, such that the first control signal is applied to the control terminal of the main switch through the first gate resistor,
in the case in which the control signal applied to the control terminal of the main switch is a second control signal, a second gate resistor being connected to the control terminal, such that the second control signal is applied to the control terminal of the main switch through the first gate resistor, and
the first gate resistor and the second gate resistor having different resistance values.

10. The wireless communication system according to claim 9, wherein the first control signal is a control signal controlling the main switch to pass the GSM signal therethrough,
wherein the second control signal is a control signal controlling the main switch to pass the WiFi signal or the Bluetooth signal therethrough, and
wherein the first gate resistor has a resistance value larger than that of the second gate resistor.

11. The wireless communication system according to claim 10, further comprising:
a low pass filter disposed between the second terminal of the main switch and the first port; and
a high pass filter disposed between the second terminal of the main switch and the second port.

12. The wireless communication system according to claim 10, further comprising:
a first switch having one end connected to the first terminal of the main switch;
a second switch having one end connected to the first terminal of the main switch; and
a diplexer having a first terminal connected to the other end of the first switch, a second terminal connected to the other end of the second switch, and a third terminal connected to the antenna,
wherein the first switch, the second switch, and the diplexer are disposed between the antenna and the first terminal of the main switch, and
wherein the first switch is turned on or off by the first control signal and the second switch is turned on or off by the second control signal.

13. The wireless communication system according to claim 11, further comprising:
a first switch having one end connected to the first terminal of the main switch;
a second switch having one end connected to the first terminal of the main switch; and
a diplexer having a first terminal connected to the other end of the first switch, a second terminal connected to the other end of the second switch, and a third terminal connected to the antenna,
wherein the first switch, the second switch, and the diplexer are disposed between the antenna and the first terminal of the main switch, and
wherein the first switch is turned on or off by the first control signal and the second switch is turned on or off by the second control signal.

14. A wireless communication system comprising:
an antenna transmitting or receiving at least two kinds of signals selected among a GSM signal, a WiFi signal, and a Bluetooth signal;
a first port connected to a first high frequency signal processing module processing the GSM signal;
a second port connected to a second high frequency signal processing module processing the WiFi signal or the Bluetooth signal;
a switching circuit connecting or blocking a path between the antenna and the first port or a path between the antenna and the second port; and
a controlling unit controlling the switching circuit,
wherein the switching circuit includes:
a main switch having a first terminal connected to the antenna, a second terminal connected to the first and second ports, and a control terminal applied with a control signal;
a third sub-switch having a first terminal connected to the control terminal of the main switch and a control terminal applied with a first control signal;
a fourth sub-switch having a first terminal connected to the control terminal of the main switch and a control terminal applied with a second control signal;
a first gate resistor having one end connected to a second terminal of the third sub-switch;
a second gate resistor having one end connected to a second terminal of the fourth sub-switch;
a first sub-switch having a first terminal connected to the other end of the first gate resistor, a second terminal connected to a control signal input terminal, and a control terminal applied with the first control signal; and
a second sub-switch having a first terminal connected to the other end of the second gate resistor, a second terminal connected to the control signal input terminal, and a control terminal applied with the second control signal,
the first gate resistor and the second gate resistor having different resistance values.

15. The wireless communication system according to claim 14, wherein the first control signal is a control signal applied to the control signal input terminal to control the main switch to pass the GSM signal therethrough,
wherein the second control signal is a control signal applied to the control signal input terminal to control the main switch to pass the WiFi signal or the Bluetooth signal, and
wherein the first gate resistor has a resistance value larger than that of the second gate resistor.

16. The wireless communication system according to claim 15, further comprising:
a low pass filter disposed between the second terminal of the main switch and the first port; and
a high pass filter disposed between the second terminal of the main switch and the second port.

17. The wireless communication system according to claim 15, further comprising:
a first switch having one end connected to the first terminal of the main switch;
a second switch having one end connected to the first terminal of the main switch; and
a diplexer having a first terminal connected to the other end of the first switch, a second terminal connected to the other end of the second switch, and a third terminal connected to the antenna,
wherein the first switch, the second switch, and the diplexer are disposed between the antenna and the first terminal of the main switch, and
wherein the first switch is turned on or off by the first control signal and the second switch is turned on or off by the second control signal.

18. The wireless communication system according to claim 16, further comprising:
a first switch having one end connected to the first terminal of the main switch;
a second switch having one end connected to the first terminal of the main switch; and
a diplexer having a first terminal connected to the other end of the first switch, a second terminal connected to the other end of the second switch, and a third terminal connected to the antenna,
wherein the first switch, the second switch, and the diplexer are disposed between the antenna and the first terminal of the main switch, and
wherein the first switch is turned on or off by the first control signal and the second switch is turned on or off by the second control signal.
